(19) United States
(12) Patent Application Publication
(10) Pub. No.: US 2009/0015983 A1
(43) Pub. Date: Jan. 15, 2009

(54) Parallel plate capacitor

(75) Inventors: Tom Allen Agan, Saint Paul, MN (US); James Chyi Lai, Saint Paul, MN (US); David Ta-Ching Chang, Saint Paul, MN (US)

Correspondence Address: MUNCY, GEISSLER, OLDS & LOWE, PLLC, 10560 Main St., Ste 213, Fairfax, VA, 22030, US

(73) Assignee: Western Lights Semiconductor Corp.

(21) Appl. No.: 11/826,176

(22) Filed: Jul. 12, 2007

(51) Int. Cl. H01G 4/005; H01G 4/06

(52) U.S. Cl. 361/303; 361/311

(57) ABSTRACT

Capacitors including a first conductive material having a first upper finger located on an upper plane and a first lower finger located on a lower plane. The capacitor also includes a second conductive material having a second upper finger and a second lower finger, the second upper finger located on the upper plane such that the second upper finger is next to the first upper finger forming a first interface and on top of the first lower finger forming a second interface, the second lower finger located on the lower plane such that the second lower finger is next to the first lower finger forming a third interface and below the first upper finger forming a fourth interface. Finally, the capacitor includes a dielectric material located in the first interface, the second interface, the third interface, and the fourth interface.

### BACKGROUND

1. Field of Invention

The present invention relates to capacitors. More particularly, the present invention relates to parallel plate capacitors.

2. Description of Related Art

Conventionally, parallel plate capacitors are structured using two conductive plates with dielectric material between the plates. The capacitance of the parallel plate capacitor can be calculated using the standard equation (1):

$$C = \frac{{e}_{0} {e}_{k} A}{r} \qquad ( 1 )$$

wherein C is the capacitance of the parallel plate capacitor, e₀ is the dielectric constant of free space (8.85×10⁻²), eₖ is the dielectric constant of the material between the parallel plates, A is the interface area of the parallel plate, and r is the distance between the parallel plates. Equation (1) showed that the capacitance of a parallel plate capacitor is proportional to the interface area of the parallel plate. For example, please refer to FIG. 1, a cross-section view of a conventional parallel capacitor structure. The conventional parallel capacitor 100 includes an upper conductive plate 102, a bottom conductive plate 104, and a dielectric layer 106 in between the plates 102 and 104. The width of the upper conductive plate 102 is 18 units. The depth of the upper conductive plate 102 is 2 units. Therefore, A is equal to 18×2=36 units² leading to a capacitance 108 proportional to A.

The structure of the parallel capacitor 100 mentioned above, one would have to increase the area of the parallel plates in order to increase the total capacitance of the parallel capacitor, assuming the eₖ and r stays the same. Therefore it is a trade off between capacitance and the size of the capacitor, introducing a bottleneck to increase the capacitance while keeping the size of the parallel plate capacitor the same.

For the forgoing reasons, there is a need for a new parallel plate capacitor with a new structure to increase the capacitance while maintaining the overall volume of the capacitor.

### SUMMARY

The present invention is directed to parallel plate capacitors, that it satisfies this need of increasing the capacitance of a parallel plate capacitor relative to a same sized conventional parallel plate capacitor. The parallel capacitor comprises a first conductive structure, a second conductive structure, and a dielectric layer. The conductive structures are individual fingers configured for each individual finger to introduce capacitance with the finger next to it and with the finger below it.

In accordance with the foregoing and other aspects of the present invention, the embodiment of the present invention is a parallel plate capacitor including the first conductive structure having a first upper finger located on an upper plane and a first lower finger located on a lower plane, the first upper finger electrically connected to the first lower finger. The second conductive structure having a second upper finger and a second lower finger, the second upper finger located on the upper plane such that the second upper finger is next to the first upper finger forming a first interface and on top of the first lower finger forming a second interface, the second lower finger located on the lower plane such that the second lower finger is next to the first lower finger forming a third interface and below the first upper finger forming a fourth interface, the second upper finger electrically connected to the second lower finger. The dielectric layer located in the first interface, the second interface, the third interface, and the fourth interface.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a cross section view of a conventional parallel plate capacitor; and

FIG. 2 is a cross section view of a parallel plate capacitor according to one preferred embodiment of this invention.

FIG. 3 is a top view of a parallel plate capacitor according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Please refer to FIG. 2, a cross section view of a parallel plate capacitor according to an embodiment of the present invention. The parallel plate capacitor 200 includes a first conductive structure 202, a second conductive structure 204, and a dielectric layer 206. The first conductive structure is composed of a first upper finger 208 and a first lower finger 210. The first upper finger 208 is located on an upper plane 212 and the first lower finger 210 is located on a lower plane 214. The first upper finger 208 is electrically connected to the first lower finger 210. The connection may be via a conductive strip 216, which will be described later.

The second conductive structure 204 is composed of a second upper finger 218 and a second lower finger 220 electrically connected together. The second upper finger 218 is located on the upper plane 212 such that the second upper finger 218 is next to the first upper finger 208, which the side surface 222 of the first upper finger 208 and the side surface 224 of the second upper finger 218 forms a first interface 226. Furthermore, the second upper finger 218 is also on top of the first lower finger 210, which the bottom surface 228 of the second upper finger 218 and the top surface 230 of the first lower finger 210 forms a second interface 232.

Similarly, the second lower finger 220 is located on the lower plane 214, next to the first lower finger 210, and on below the first upper finger 208. Therefore, the second lower finger 220 forms a third interface 234 and a fourth interface 236 with the first upper finger 208 and the first lower finger 210.

The dielectric layer 206 is located between all the interfaces. Each interface 226, 232, 234, and 236 introduces a first capacitance 238, a second capacitance 240, a third capacitance 242, and a fourth capacitance 244, respectively. Therefore, the total capacitance introduced by the capacitor with the interfaces 226, 232, 234, and 236 is the sum of the capacitances 238, 240, 242, and 244. For example, if each interface introduces 4 units of capacitance, then when a voltage difference is applied between the first conductive structure 202 and the second conductive structure 204, the total capacitance introduced by the four interfaces 226, 232, 234, and 236 is 16 units.

The parallel capacitor structure may be expanded further as illustrated by FIG. 2. A third upper finger 246 and a third lower finger 248 may be included in the first conductive structure 202 and the second conductive structure 204, respectively, to introduce additional capacitances 250, 252, and 254. The third upper finger 246 is located on the other side of the second upper finger 218 opposite to the first upper finger 208. The third lower finger 248 is located below the third upper finger 246. Similarly, the parallel capacitor 200 may be expanded further according to the same pattern, where all the fingers of the first conductive structure 202 are electrically connected with each other. All the fingers of the second conductive structure 204 are electrically connected with each other.

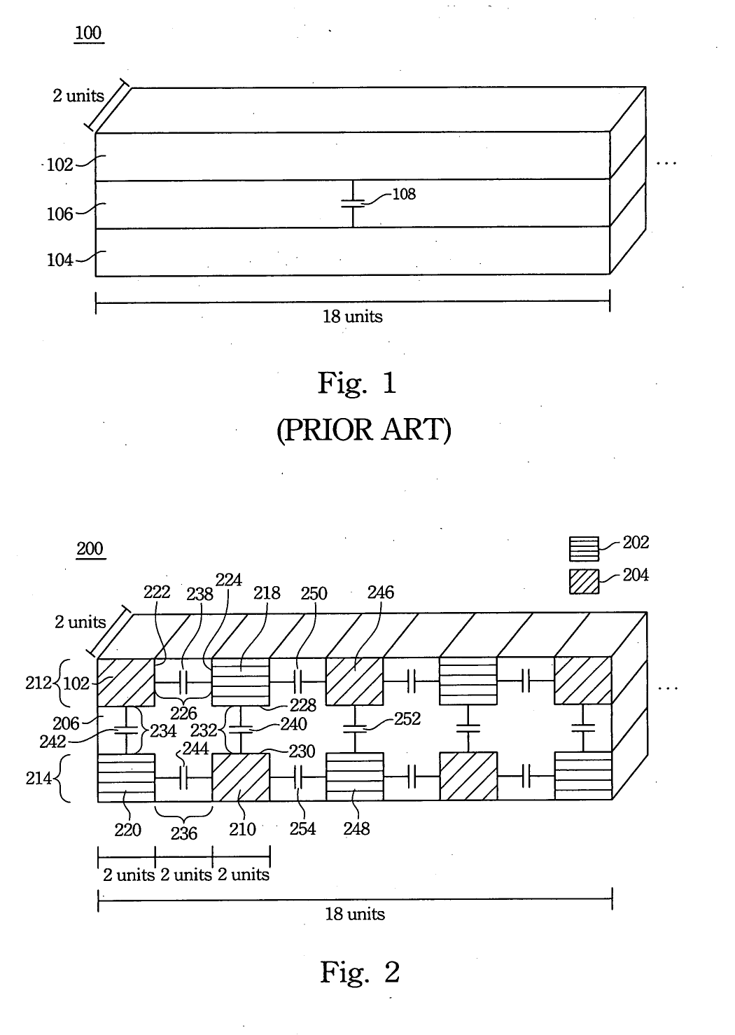

In order to illustrate that for the two parallel plate capacitors with the same dimension, namely capacitor 100 and capacitor 200, capacitor 200 introduces more capacitance than capacitor 100. Assuming the first upper finger 208 has a dimension of 2×2 (width=2 units, depth=2 units) and each finger in capacitor 200 has the same dimension. Therefore, the first capacitance 238 is proportional to 4 units² and all other capacitances (capacitances 240, 242, 244 . . . etc) have values of 4 units². Thus in FIG. 2, assuming the distance between the fingers are also 2 units, a total of 13 4 units² capacitances are introduced in a 18 unit wide, 2 unit deep parallel plate capacitor 200. The sum of the 13 capacitances equaled to be 52 units² of total capacitance. Compared this result with the 36 units² of capacitance in the parallel plate capacitor 100 shown in FIG. 1, the capacitance in the capacitor 200 is almost 1.5 times the capacitance in the capacitor 100, an increase of almost 50%.

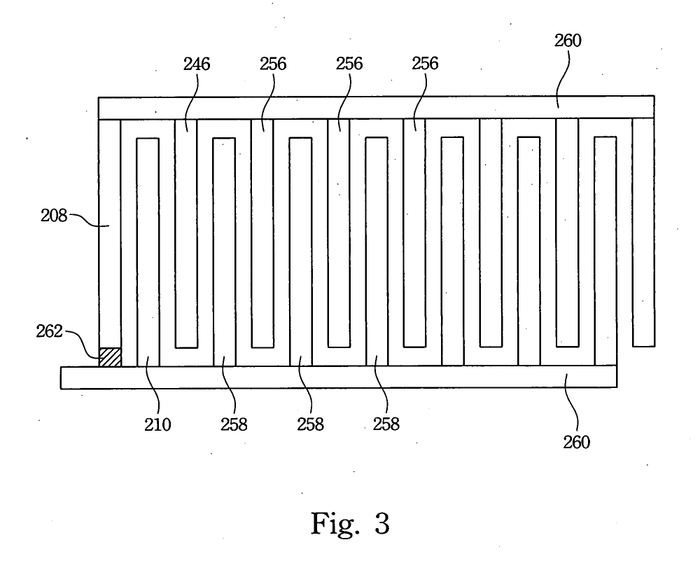

Please refer to FIG. 3, a top view of the first conductive structure 202 according to an embodiment of the present invention. The first upper finger 208, the third upper finger 246, and the similarly configured upper fingers 256 are located on the upper plane 212. The first lower finger 210 and the similarly configured lower fingers 258 are located on the lower plane 214. The fingers of the first conductive structure on the upper plane 212 are electrically connected via a conductive strip 260 as previously mentioned. The fingers of the first conductive structure on the lower plane 214 are electrically connected via a conductive strip 216. From the top view of the parallel capacitor in FIG. 3, notice the fingers on the upper plane 212 can be electrically connected to the fingers on the lower plane 214 via a short interconnect 262 on either ends of the first conductive structure 202.

From the above described embodiment of the present invention, more capacitance is introduced within the same volume of materials as conventional parallel plate capacitors. Not only is the capacitance increased, less conductive material is needed since the fingers introduce capacitance with the fingers on different planes and adjacent fingers, where as the conventional parallel plate capacitors only introduces capacitance between the planes. Thus more dielectric material is used. Therefore, the disclosed parallel plate capacitor will be lighter in weight.

On the other hand, if the capacitance needed not to be increased, the volume of the capacitor can be reduced using the disclosed structure to obtain the same capacitance as a conventional parallel plate capacitor. Also, the disclosed capacitor may be expanded into multiple planes using the same structural geometry. From the above embodiment, a structural pattern can be observed. The structural pattern is two first pillar electrodes located at opposite corners and different planes, and two second pillar electrodes located on the remaining corners of the different planes. For example, if the first electrodes are located at the right corner of a first plane and the left corner of a second plane, then the second electrodes are located at the left corner of a first plane and the right corner of the second plane. A dielectric layer is located between the electrodes forming capacitances.

According to the above mentioned structural pattern, a third plane may be added below the second plane to expand the capacitor. On the third plane, a third pillar electrode and a fourth pillar electrode are located thereon to form additional capacitances with each other and with the electrodes in the second plane.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A plurality of parallel plate capacitors, comprising:
a first conductive material having a first upper finger located on an upper plane and a first lower finger located on a lower plane, the first upper finger electrically connected to the first lower finger;
a second conductive material having a second upper finger and a second lower finger, the second upper finger located on the upper plane such that the second upper finger is next to the first upper finger forming a first interface and on top of the first lower finger forming a second interface, the second lower finger located on the lower plane such that the second lower finger is next to the first lower finger forming a third interface and below the first upper finger forming a fourth interface, the second upper finger electrically connected to the second lower finger; and
a dielectric material located in the first interface, the second interface, the third interface, and the fourth interface.

2. The parallel plate capacitors of claim 1, wherein the first upper finger, the second upper finger, the first lower finger and the second lower finger are metal lines.

3. The parallel plate capacitors of claim 1, wherein the first interface, the second interface, the third interface and the fourth interface introduce a first capacitance, a second capacitance, a third capacitance and a fourth capacitance respectively, when the first conductive material and the second conductive material are electrically biased.

4. The parallel plate capacitors of claim 3, wherein the first capacitance, the second capacitance, the third capacitance, and the fourth capacitance sum into a total capacitance of the parallel plate capacitor.

5. The parallel plate capacitors of claim 1, the first conductive material further comprises a third upper finger located on the upper plane such that the third upper finger is next to the second upper finger on the opposite side of the first upper finger, whereby forming a fifth interface, and the third upper finger electrically connected to the first lower finger.

6. The parallel plate capacitors of claim 5, wherein the fifth interface introduces a fifth capacitance to the capacitor.

7. The parallel plate capacitors of claim 5, the second conductive material further comprises a third lower finger located on the lower plane such that the third lower finger is below the third upper finger forming a sixth interface, and the third lower finger electrically connected to the second upper finger.

8. The parallel plate capacitors of claim 7, wherein the sixth interface introduces a sixth capacitance to the parallel plate capacitor.

9. A plurality of parallel plate capacitors, comprising:
two first pillar electrodes electro-connecting with each other and located at right corner of a first plane and left corner of a second plane respectively;
two second pillar electrodes electro-connecting with each other and located at left corner of the first plane and right corner of the second plane respectively; and
a dielectric layer located between the first electrodes and the second electrodes, wherein the first pillar electrodes and the second pillar electrodes form capacitances therebetween.

10. The parallel plate capacitors of claim 9, wherein the first pillar electrode having a first electric potential and the second pillar electrodes having a second electric potential different from the first electric potential.

11. The parallel capacitors of claim 9, wherein the first plane is on top of the second plane.

12. The parallel plate capacitors of claim 9, the parallel capacitor further comprises:
a third pillar electrode located at a right corner of a third plane, such that the third plane is below the second plane; and
a fourth pillar electrode located at a left corner of the third plane.

13. The parallel plate capacitors of claim 12, wherein the third pillar electrode has the first electric potential and the fourth pillar electrode has the second electric potential.

14. The parallel plate capacitors of claim 12, wherein the dielectric layer is located between the third and fourth pillar electrode, the second and third electrode and the first and fourth electrode.
